(19) United States
(12) Patent Application Publication
(10) Pub. No.: US 2010/0001943 A1
(43) Pub. Date: Jan. 7, 2010

(54) HEATING SYSTEM FOR DISPLAY PANEL AND DISPLAY PANEL USING THE SAME

(75) Inventors: Hon-Yuan Leo, Tainan County (TW); Ju-Tien Cheng, Tainan County (TW); Kuan-Hsu Fan-Chiang, Tainan County (TW); Fu-Yuan Wu, Tainan County (TW); Yen-Chen Chen, Tainan County (TW)

Correspondence Address: J C PATENTS, 4 VENTURE, SUITE 250, IRVINE, CA, 92618, US

(73) Assignee: Himax Display, Inc., Tainan County (TW)

(21) Appl. No.: 12/168,286

(22) Filed: Jul. 7, 2008

(51) Int. Cl. G09G 3/36

(52) U.S. Cl. 345/101

(57) ABSTRACT

A heating system for a display panel is provided herein, wherein the display panel has a display area. The heating system includes a sensor, a temperature controlling device, and a heating element. The sensor is used for sensing the temperature of the display panel. The temperature controlling device provides a control signal according to the temperature of the display panel. The heating element heats the display panel according to the control signal, and the heating element is a patterned circuitry disposed on a peripheral region of the display area.

### BACKGROUND OF THE INVENTION

1. Field of the Invention

The present invention relates to a heating system for a display panel, and more particularly, to a heating system that can heat the display panel to a predetermined temperature.

2. Description of Related Art

With great advance in the techniques of electro-optical and semiconductor devices, flat panel displays, such as liquid crystal displays (LCD), have enjoyed burgeoning development and flourished in recent year. Due to the numerous advantages of the LCD, such as low power consumption, free of radiation, and high space utilization, the LCD has become the main stream in the market.

Among the display devices employing the LCD device, a liquid crystal projector has been a practical application. The liquid crystal projector illuminates a liquid crystal display element with light emitted from a light source and projects the images displayed by the liquid crystal display element to a screen. Liquid crystal on silicon (LCOS) display device is a well-known reflective type liquid crystal display device for optical projection systems. LCOS display devices include an array of display pixels fabricated on a silicon substrate or other semiconductor substrates with associated control circuitry, and an amount of liquid crystal material encapsulated to overlie the display pixel array. When appropriate electrical signals are applied to the various pixels, they alter the transparency or polarization or reflectivity of the liquid crystal material which overlies the respective areas of the various pixels.

Even though the LCOS projection system has advantages of its small size, high definition display and high luminance cooperating with light emitting diodes (LEDs), the display pixels and the illuminator are often temperature dependent. FIG. 1A is a curve diagram of the NTSC color gamut variation in response to the operation temperature of the liquid crystal display panel. As shown in FIG. 1A, the NTSC color gamut improves in accordance with the increasing operation temperature. Further, FIG. 1B illustrates a curve diagram of the response time of the liquid crystal in response to the operation temperature of the liquid crystal display. Referring to FIG. 1B, the response time of the liquid crystal becomes slower under the lower operation temperature. In other words, the liquid crystal material does not behave in a consistent manner below a particular temperature. Accordingly, the liquid crystal material in such situations must be heated to a desired temperature in order to achieve satisfactory functionality. Therefore, to avoid said defects, a heating system is needed for liquid crystal display panel to better display quality.

### SUMMARY OF THE INVENTION

The present invention provides a heating system that can quickly heat a display panel to a predetermined temperature for enhancing display quality. In addition, the present invention provides a display panel using the said heating system for heating accordingly.

A heating system for a display panel is provided in the present invention, wherein the display panel has a display area. The heating system includes a sensor, a temperature controlling device, and a heating element. The sensor senses a temperature of the display panel. The temperature controlling device provides a control signal according to the temperature of the display panel and a predetermined temperature. The heating element heats the display panel according to the control signal. The heating element is a patterned circuitry disposed on a peripheral region of the display area.

A display panel is provided in the present invention. The display panel has a plurality of pixel cells formed at each intersection of a plurality of scan lines and a plurality of data lines within a display area. The display panel includes a sensor, a temperature controlling device, and a heating element. The temperature controlling device provides a control signal according to a temperature of the display panel sensed by the sensor and a predetermined temperature. The heating element heats the display panel according to the control signal. The heating element is a patterned circuitry disposed on the display area.

The present invention provides the heating system and the display panel using the same that decide whether the display panel is heated according to the temperature of the display panel. Since the color gamut displayed by the display panel and the response time of liquid crystal vary with the operation temperature of the display panel. The heating system is utilized for heating the display panel to the predetermined temperature for enhancing the according display behavior.

In order to make the features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a curve diagram of the NTSC color gamut variation in response to the operation temperature of the liquid crystal display panel.

FIG. 1B is a curve diagram of the response time of the liquid crystal in response to the operation temperature of the liquid crystal display.

FIG. 2 is a simplified diagrammatic front view of a display panel according to an embodiment of the present invention.

FIG. 3 is a block diagram of the temperature controlling device according to the embodiment in FIG. 2.

FIG. 4 is a circuit diagram of the heating element according to the embodiment in FIG. 2.

FIG. 5 is a block diagram of the temperature controlling device according to the embodiment in FIG. 2.

FIG. 6 is a simplified diagrammatic front view of a display panel according to another embodiment of the present invention.

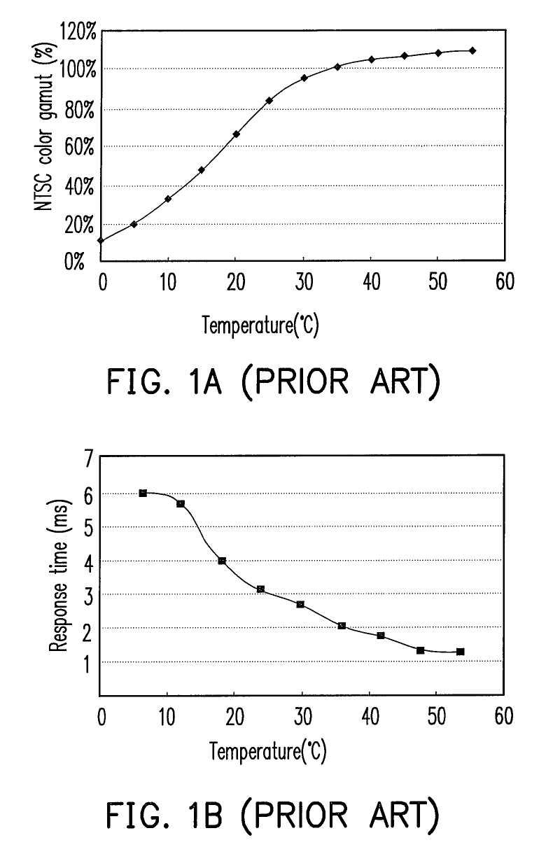

### DESCRIPTION OF EMBODIMENTS

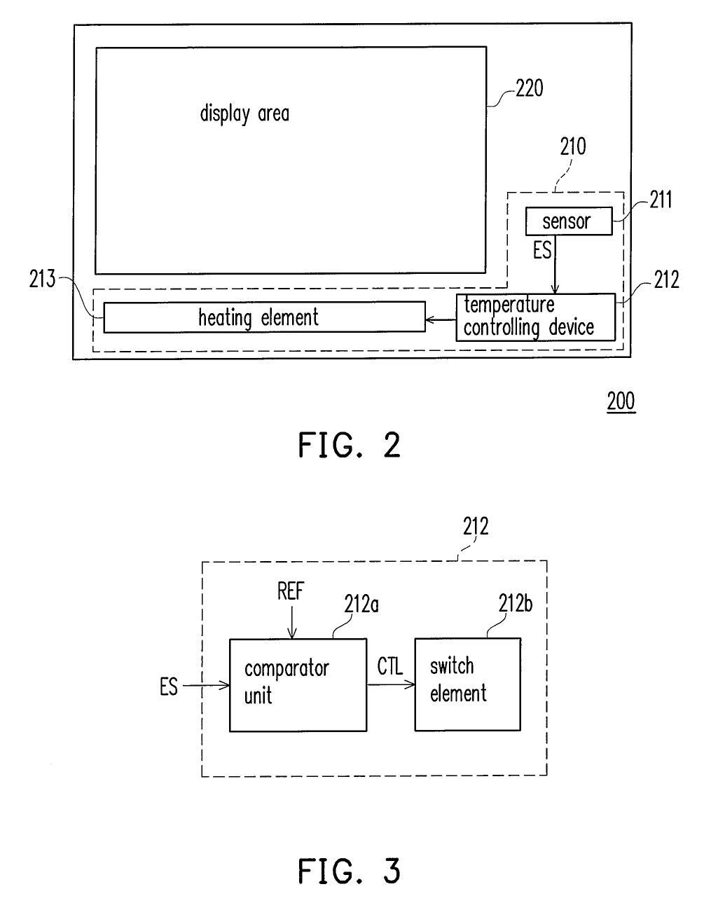

FIG. 2 is a simplified diagrammatic front view of a display panel according to an embodiment of the present invention. The display panel 200 is exemplary an LCOS panel, but not limited in the embodiment of the present invention. Referring to FIG. 2, it is assumed that a heating system 210 is disposed on the display panel 200, wherein the display panel 200 includes a display area 220 composed of plural pixel cells (not illustrated in FIG. 2), and a peripheral region surrounding the display area 220. The heating system 210 includes a sensor 211, a temperature controlling device 212, and a heating element 213. The sensor 211 senses a temperature of the display panel 200 and then outputs an electrical signal ES corresponding to the sensed temperature of the display panel 200.

At least one predetermined temperature is set in the temperature controlling device 212. After receiving the electrical signal ES from the sensor 211, the temperature controlling device 212 generates a control signal according to the sensed temperature of the display panel 200 and the predetermined temperature and transmits the control signal to the heating element 213. Moreover, the operating state of the heating element 213 is in response to the control signal. If the temperature of the display panel 200 is lower than the predetermined temperature in the temperature controlling device 212, the heating element 213 start heating to increase the temperature of the display panel 200. The heating element 213 is a patterned circuitry disposed on the peripheral region of the display area 220. The sensor 211 and the patterned circuitry are formed in a same substrate of the display panel. As shown in FIG. 2, the heating element 213 is disposed on one side of the peripheral region of the display area 220 in the embodiment of the present invention, but it should not be limited in the embodiment. Actually, the heating element 213 can be disposed on two sides of the peripheral region or even surrounding the display area 220 in another embodiment. The detail of the temperature controlling device will be described subsequently.

FIG. 3 is a block diagram of the temperature controlling device 212 according to an embodiment of the invention. Referring to FIG. 2 and FIG. 3, the temperature controlling device 212 includes a comparator unit 212a and a switch element 212b. The comparator unit 212a, for example, is a comparator for comparing the electrical signal ES corresponding to the temperature of the display panel 200 with a reference value REF corresponding to the predetermined temperature. As mentioned above, the color gamut of the display and the response time of the liquid crystal suffer from the low operation temperature issue. Accordingly, the display panel 200 needs to be heated to improve related behavior. If the electrical signal ES is less than the reference value REF, in other words, the operation temperature of the display panel 200 is lower than the predetermined temperature; the comparator unit 212a generates a control signal CTL to turn on the switch element 212b. In the meanwhile, the switch element 212b conducts a power source to the heating element 213 in response to the control signal CTL, so as to start the heating element 213 to operate. On the contrary, if the electrical signal ES is greater than the reference value REF, in other words, the operation temperature of the display panel 200 is higher than the predetermined temperature; the comparator unit 212a generates the control signal CTL to turn off the switch element 212b. In the embodiment of the present invention, the switch element 212b can be implemented by transistors or any semiconductor switching elements.

It is noted that the reference value REF corresponding to the predetermined temperature can be stored within a register (not illustrated in FIG. 3) or other memory devices. That is to say, the reference value REF is adjustable by setting the register. Consequently, the predetermined temperature can be changed by demand.

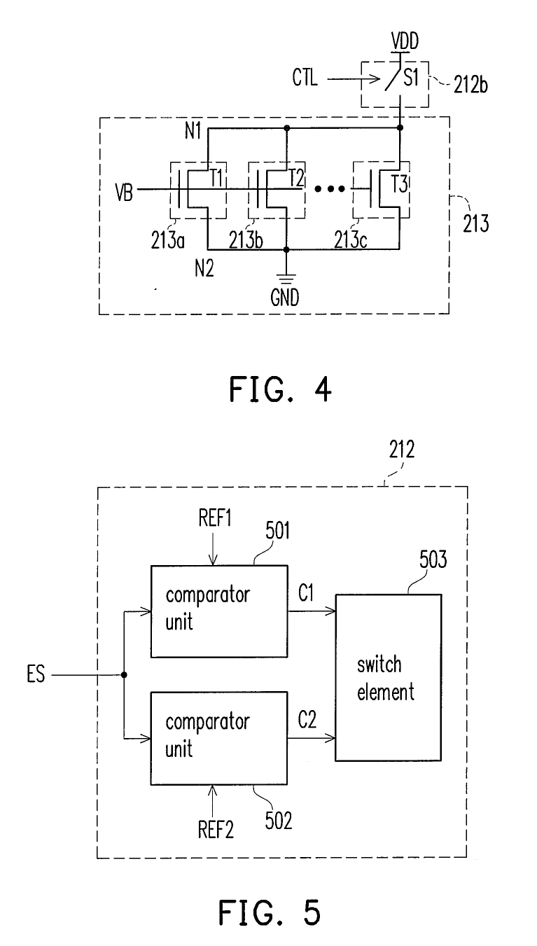

FIG. 4 is a circuit diagram of the heating element 213 according to the embodiment in FIG. 2. Referring to FIG. 4, the heating element 213 includes a plurality of parallel connected resistors 213a, 213b and 213c. For the LCOS panel in the embodiment, the resistors 213a, 213b and 213c can be respectively fabricated by transistors T1, T2 and T3 thereon, but it is not limited to the number of the resistor and the kind of semiconductor resistance element employed to implement the resistor. As shown in FIG. 4, each of the transistor T1 through T3 has a control terminal coupled to a bias voltage VB, and a first terminal N1 and a second terminal N2 respectively coupled to the power source VDD and ground source GND. The switch element 212b is adapted to conduct the power source to the heating element 213 for starting the heating element 213, wherein the switch element 212b is represented by a switch S1 herein.

Further, when the sensed temperature of the display panel 200 is lower than the predetermined temperature, the switch S1 conducts the power source VDD to the heating element 213 in response to the control signal CTL. Accordingly, the current passes through the transistors T1 through T3 and generates thermal energy. The heating element 213 increases the temperature of the display panel 200 until the predetermined temperature. Although the heating element 213 is implemented by parallel connected resistors in the embodiment of FIG. 4, the heating element 213 can be practiced by a plurality of series connected resistors in another embodiment. In addition, any semiconductor resistance elements may be implemented and performed the equivalent function, such as poly resistors or diffusion resistors. The patterned circuitry of the heating element 213 and the sensor 211 can be formed in a substrate of the display panel 200.

FIG. 5 is a block diagram of the temperature controlling device 212 according to the embodiment in FIG. 2. Referring to FIG. 2 and FIG. 5, the temperature controlling device 212 includes a first comparator unit 501, a second comparator unit 502, and a switch element 503. The first comparator unit 501 compares the electrical signal ES with a reference value REF 1 corresponding a first predetermined temperature, e.g. 30° C., and the second comparator unit 502 compares the electrical signal ES with a reference value REF2 corresponding to a second predetermined temperature, e.g. 40° C. The reference values REF1 and REF2 can be stored within the registers, and the reference values REF1 and REF2 are adjustable by setting the registers. The comparator units 501 and 502 define a temperature range, e.g. 30° C.˜40° C. by the reference values REF1 and REF2, and furthermore the heating element 213 can be performed to operate in accordance with the defined temperature range. For the embodiment of the present invention, the heating element 213 starts to heat when the temperature of the display panel 200 is less than the temperature range and keeps heating until the temperature of the display panel 200 exceeds the temperature range. Hence, the control signal (not illustrated in FIG. 5) is altered according to the outputs C1 and C2 of the comparator units 501 and 502 for controlling the operation of the heating element 213.

For detailed description, it is assumed that the reference value REF1 is greater than the reference value REF2. If the electric signal ES is less than the reference value REF2, the outputs C1 and C2 of the comparator units 501 and 502 are provided for generating the control signal to conduct the power source to the heating element 213. The control signal may be obtained by performing a simple logic processing, e.g. OR gate processing, on the outputs C1 and C2. If the electric signal ES is greater than the reference value REF1, the outputs C1 and C2 of the comparator units 501 and 502 are provided for generating the control signal to disconnect the power source to the heating element 213, and then the heating element 213 stop operating. People skilled in the art should understand that the temperature range may be more than one. In other words, the number of the comparator units is not limited and should be defined by requirement.

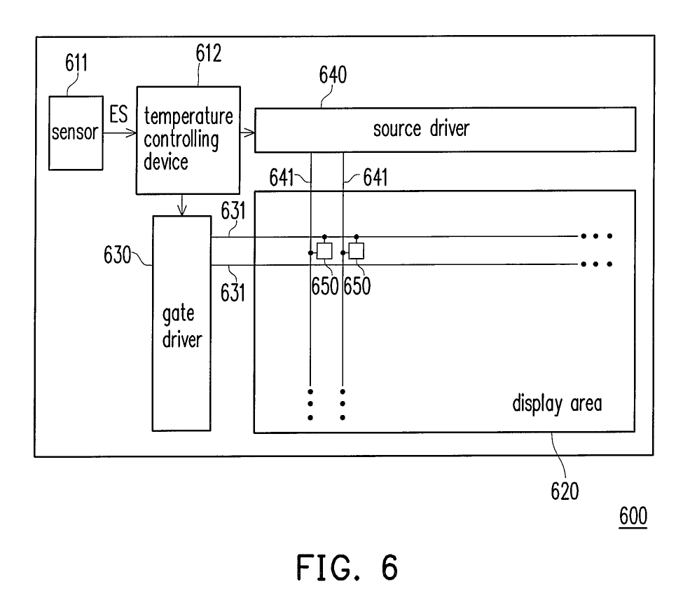

FIG. 6 is a simplified diagrammatic front view of a display panel according to another embodiment of the present invention. The display panel 600 has a plurality of pixel cells 650 formed at each intersection of a plurality of scan lines 631 and a plurality of data lines 641 within a display area 620. The display panel 600, for example, is a liquid crystal on silicon (LCOS) panel. The display panel 600 includes a sensor 611, a temperature controlling device 612, and a heating element, wherein the heating element is composed of the scan lines 631 or the data lines 641. Similar to the embodiment in FIG. 2, the sensor 611 senses a temperature of the display panel 600, and thereby outputs an electric signal ES corresponding to the sensed temperature of the display panel 600. The temperature controlling device 612 generates a control signal according to the sensed temperature of the display panel 600 and a predetermined temperature to the heating element for controlling the operating state thereof.

The temperature controlling device 612 can be implemented the same as mentioned previously, such as shown in FIG. 4 or in FIG. 5. For convenience, it is assumed that the heating element is composed of the scan lines 631, and the temperature controlling device 612 is integrated into the gate driver 630 herein. Each scan line 631 is equivalent to a resistance element, and generates thermal energy when current passing through. Hence, if the temperature of the display panel 600 is sensed to be less than the predetermined temperature, the temperature controlling device 612 conducts the power source to the scan lines 631 for heating the display panel 600.

To reason by analogy, the heating element can be composed of the data lines 641, and the temperature controlling device 612 is integrated into the source driver 640. Similarly, the data lines 641 generate thermal energy for heating the display panel 600 by conducting to power source in response to the temperature controlling device 612. Additionally, both of the scan lines 631 and the data lines 640 can be employed in heating elements at the same time in the embodiment.

In summary, the said embodiments provide the heating system for heating the display panel in order to solve the low operation temperature issue of the color gamut of display panel and the response time of the liquid crystal. The provided heating system senses the temperature of the display panel and determines to heat or not. If the temperature of the display panel is less than the predetermined temperature, the heating element generates thermal energy for heating the display panel. The heating element can be patterned circuitry disposed on the peripheral region of the display area or the signal lines disposed on the display area. By utilizing the provided heating function, the cost and the layout area can be reduced and the display quality can be enhanced accordingly.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A heating system for a display panel having a display area, the heating system comprising:
a sensor for sensing a temperature of the display panel;
a temperature controlling device for providing a control signal according to the temperature of the display panel and a predetermined temperature; and
a heating element for heating the display panel according to the control signal,
wherein the heating element is a patterned circuitry disposed on a peripheral region of the display area.

2. The heating system as claimed in claim 1, wherein the sensor outputs an electrical signal corresponding to the temperature of the display panel.

3. The heating system as claimed in claim 2, wherein the temperature controlling device comprises:
a first comparator unit for comparing the electrical signal of the sensor with a first reference value corresponding to a first predetermined temperature.

4. The heating system as claimed in claim 3, wherein the temperature controlling device further comprises:
a second comparator unit for comparing the electrical signal of the sensor with a second reference value corresponding to a second predetermined temperature.

5. The heating system as claimed in claim 4, wherein the provided control signal is altered according to the outputs of the first comparator unit and the second comparator unit.

6. The heating system as claimed in claim 4, wherein the first reference value and the second reference value are adjustable.

7. The heating system as claimed in claim 1, wherein the temperature controlling device comprises:
a switch element for conducting the heating element to a power source in response to the control signal.

8. The heating system as claimed in claim 1, wherein the patterned circuitry of the heating element comprises a plurality of parallel connected resistors.

9. The heating system as claimed in claim 8, wherein the resistors are implemented by transistors.

10. The heating system as claimed in claim 1, wherein the sensor and the patterned circuitry of heating element are formed in a same substrate of the display panel.

11. A display panel having a plurality of pixel cells formed at each intersection of a plurality of scan lines and a plurality of data lines within a display area, the display panel comprising:
a sensor for sensing a temperature of the display panel;
a temperature controlling device for providing a control signal according to the temperature of the display panel and a predetermined temperature; and
a heating element for heating the display panel according to the control signal,
wherein the heating element is a patterned circuitry disposed on the display area.

12. The display panel as claimed in claim 11, wherein the sensor outputs an electrical signal corresponding to the temperature of the display panel.

13. The display panel as claimed in claim 12, wherein the temperature controlling device comprises:
a first comparator unit for comparing the electrical signal of the sensor with a first reference value corresponding to a first predetermined temperature.

14. The display panel as claimed in claim 13, wherein the temperature controlling device further comprises:
a second comparator unit for comparing the electrical signal of the sensor with a second reference value corresponding to a second predetermined temperature.

15. The display panel as claimed in claim 14, wherein the provided control signal is altered according to the outputs of the first comparator unit and second comparator unit.

16. The display panel as claimed in claim 14, wherein the first reference value and the second reference value are adjustable.

17. The display panel as claimed in claim 11, wherein the temperature controlling device comprises:
a switch element for conducting the heating element to a power source in response to the control signal.

18. The display panel as claimed in claim 11, wherein the patterned circuitry of the heating element comprises a plurality of parallel connected resistors.

19. The display panel as claimed in claim 18, wherein the resistors are the scan lines or the data lines.

20. The display panel as claimed in claim 11, wherein the display panel is an LCOS panel.
